(19) United States
(12) Patent Application Publication
(10) Pub. No.: US 2008/0106498 A1
(43) Pub. Date: May 8, 2008

(54) Plasma display device and driving method thereof

(75) Inventor: Seung-Hun Chae, Suwon-si (KR)

Correspondence Address: LEE & MORSE, P.C., 3141 FAIRVIEW PARK DRIVE, SUITE 500, FALLS CHURCH, VA, 22042, US

(73) Assignee: Samsung SDI Co., Ltd.

(21) Appl. No.: 11/976,083

(22) Filed: Oct. 19, 2007

(30) Foreign Application Priority Data
Nov. 7, 2006 (KR) 10-2006-0109455

(51) Int. Cl. G09G 3/28

(52) U.S. Cl. 345/60

(57) ABSTRACT

A method for driving a plasma display device having a plurality of row electrodes and a plurality of discharge cells corresponding to the row electrodes, in which a field is divided into a plurality of subfields, the method including dividing the plurality of row electrodes into at least a first row group and a second row group, dividing the first row group into a plurality of first subgroups, dividing the second row group into a plurality of second subgroups, and address-discharging one of the first subgroups while sustain-discharging a corresponding one of the second subgroups during a predetermined subfield of a first field, wherein at least one row electrode is part of one subgroup in a first field, and the at least one row electrode is part of another subgroup in a second field.

### CROSS-REFERENCE TO RELATED APPLICATION

This application is related to co-pending U.S. patent application Ser. No. ______, entitled “PLASMA DISPLAY DEVICE AND DRIVING METHOD THEREOF,” which was filed on Oct. 19, 2007, and which is incorporated by reference herein in its entirety.

### BACKGROUND OF THE INVENTION

1. Field of the Invention

Embodiments relate to a plasma display device and a method of driving the same.

2. Description of the Related Art

A plasma display device is a flat panel display device that uses plasma generated by a gas discharge to display images, e.g., text, video, etc. It may include a plasma display panel (PDP) having, depending on its size, tens to millions of discharge cells, which may be arranged in a matrix format.

In operation of the plasma display device, a field (e.g., one TV field) may be divided into respectively weighted subfields. Grayscales may be expressed by a combination of weights from among the subfields. A discharge cell to be turned on, i.e., to be placed in a light-emitting state, may be selected by performing an addressing discharge for an address period of each subfield. The turned-on, i.e., light-emitting, discharge cell may be sustain-discharged during a period corresponding to a weight of the corresponding subfield in a sustain period of each field. The plasma display may use a plurality of subfields each having a different weight in order to express grayscales. A sum of weight values of subfields having discharge cells in the light emitting state among a plurality of subfields may represent a gray scale of the corresponding discharge cell.

The operation described above of expressing grayscales using subfields may cause a dynamic false contour. For example, when using subfields with weights set to 2″, a dynamic false contour may occur when discharge cells express grayscales of 127 and 128 in consecutive frames.

An additional address period may be provided to each subfield for addressing all discharge cells, in addition to the sustain period for sustain-discharging, which may increase the length of a subfield. The increased length of the subfield may limit the number of subfields that can be used in a field.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a plasma display device and driving method thereof, which substantially overcome one or more of the problems due to the limitations and disadvantages of the related art.

It is therefore a feature of an embodiment to provide a plasma display device, and a method of driving the same, in which a plurality of row electrodes may be divided into groups, which may in turn be further divided into subgroups, and in which an address period of one subgroup may be performed while a sustain period of another subgroup is being performed.

It is therefore another feature of an embodiment of the present invention to provide a plasma display device, and a method of driving the same, in which a luminance difference between subgroups may be reduced by changing a subgroup to which at least one row electrode is assigned.

At least one of the above and other features and advantages may be realized by providing a method for driving a plasma display device having a plurality of row electrodes and a plurality of discharge cells corresponding to the row electrodes, in which a field is divided into a plurality of subfields, the method including dividing the plurality of row electrodes into at least a first row group and a second row group, dividing the first row group into a plurality of first subgroups, dividing the second row group into a plurality of second subgroups, and address-discharging one of the first subgroups while sustain-discharging a corresponding one of the second subgroups during a predetermined subfield of a first field, wherein at least one row electrode is part of one subgroup in a first field, and the at least one row electrode is part of another subgroup in a second field.

The at least one row electrode may be part of the first row group in the first field, and the at least one row electrode may be part of the second row group in a second field. The at least one row electrode may be part of a first subgroup in the first field, and the at least one row electrode may be part of a second first subgroup in a second field.

The row electrodes of the one subgroup and the row electrodes of the other subgroup may be physically adjacent to each other. The at least one row electrode may be positioned in an area adjacent to a boundary between the one subgroup and the other subgroup. A boundary between subgroups may move from a first physical region of the display to a second physical region of the display when the first field changes to the second field. The at least one row electrode may be a scan electrode. The second field may be consecutive to the first field.

The at least one row electrode may be part of the one subgroup in a third field, and the first, second and third fields may be consecutive. Each subgroup may include an equal number of row electrodes during the first and second fields, and a set of row electrodes forming the one subgroup during the first field may be different from a set of row electrodes forming the one subgroup during the second field.

At least one of the above and other features and advantages may also be realized by providing a plasma display device, including a plasma display panel having a plurality of row electrodes and a plurality of discharge cells corresponding to the row electrodes, a controller configured to divide the plurality of row electrodes into at least a first row group and a second row group, to divide the first row group into a plurality of first subgroups, and to divide the second row group into a plurality of second subgroups, and a driver configured to address-discharge one of the first subgroups while sustain-discharging a corresponding one of the second subgroups during a predetermined subfield of a first field. At least one row electrode may be part of one subgroup in a first field, and the at least one row electrode may be part of another subgroup in a second field.

The at least one row electrode may be part of the first row group in the first field, and the at least one row electrode may be part of the second row, group in a second field. The at least one row electrode may be part of a first subgroup in the first field, and the at least one row electrode may be part of a second first subgroup in a second field. The row electrodes of the one subgroup and the row electrodes of the other subgroup may be physically adjacent to each other. The at least one row electrode may be positioned in an area adjacent to a boundary between the one subgroup and the other subgroup.

A boundary between subgroups may move from a first physical region of the display to a second physical region of the display when the first field changes to the second field. The at least one row electrode may be a scan electrode. The second field may be consecutive to the first field. The at least one row electrode may be part of the one subgroup in a third field, and the first, second and third fields may be consecutive. Each subgroup may includes an equal number of row electrodes during the first and second fields, and a set of row electrodes forming the one subgroup during the first field may be different from a set of row electrodes forming the one subgroup during the second field.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plasma display device according to an embodiment;

FIG. 2 illustrates a grouping of electrodes in a method of driving a plasma display device according to an embodiment;

FIG. 3 illustrates subfields in the driving method of FIG. 2;

FIG. 4 illustrates another view of subfields in the driving method of FIG. 2; and

FIG. 5 illustrates details of electrode grouping in the driving method of FIG. 2.

### DETAILED DESCRIPTION OF THE INVENTION

Korean Patent Application No. 10-2006-0109455, filed on Nov. 7, 2006, in the Korean Intellectual Property Office, and entitled: “Plasma Display and Driving Method Thereof,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

As used herein, “wall charges” refer to charges formed and accumulated on a wall (e.g., a dielectric layer) close to an electrode of a discharge cell. A wall charge may be described as being “formed” or “accumulated” on the electrodes, although the wall charges may not actually touch the electrodes. Further, a “wall voltage” refers to a potential difference formed on the wall of the discharge cell by the wall charge.

Address-discharging may include a selective writing method to select discharge cells that are to emit light (hereinafter referred to as light emitting cells). A selective erase method may be used to select discharge cells that are to emit no light (hereinafter referred to as non-light emitting cells). The selective writing method may select a discharge cell that is to be a light emitting cell and generate a constant wall voltage. Using the selective writing method, cells that are in the non-light emitting state may be address-discharged, such that wall charges may be formed and the non-light emitting state may be switched to the light emitting state. The address-discharge that forms the wall charge in the selective write method may be called a “write discharge.”

The selective erase method may select a cell that is to be a non-light emitting cell and erase the wall voltage. Using the selective erase method, cells in the light emitting state may be address-discharged, such that wall charges that had already been formed are erased and the light emitting state may be switched to the non-light emitting state. The address discharge that erases the wall charge in the selective erase method may be called an “erase discharge.”

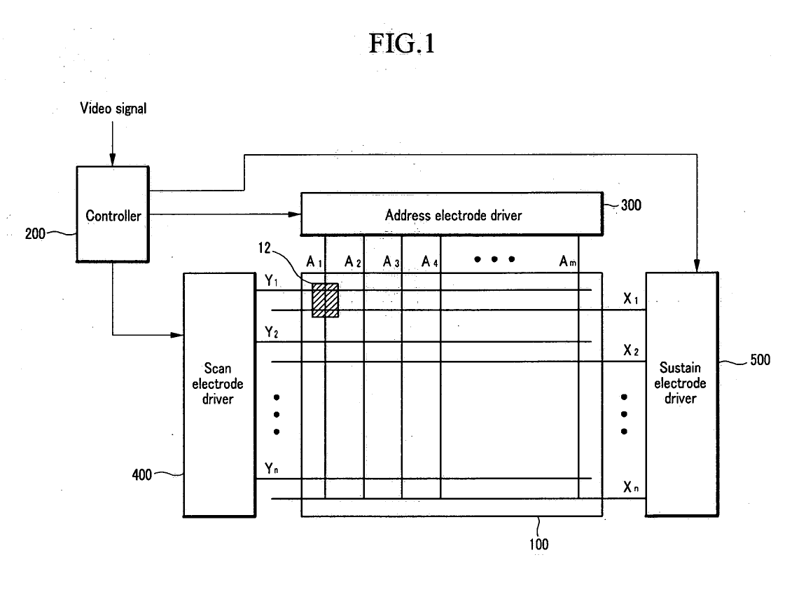

FIG. 1 illustrates a plasma display device according to an embodiment. Referring to FIG. 1, the plasma display device may include a PDP 100, a controller 200, an address electrode driver 300, a scan electrode driver 400, and a sustain electrode driver 500.

The PDP 100 may include a plurality of address electrodes A₁ to Aₘ, which may extend in a column direction. The PDP 100 may also include a plurality of sustain electrodes X₁ to Xₙ and a plurality of scan electrodes Y₁ to Yₙ, which may extend in a row direction, i.e., crossing the address electrodes A₁ to Aₘ. The Y electrodes Y₁ to Yₙ and the X electrodes X₁ to Xₙ may extend parallel to each other. The address electrodes, the sustain electrodes, and the scan electrodes will be generally referred to as A electrodes, X electrodes, and Y electrodes, respectively. The X and Y electrodes may be generally referred to as row electrodes, and the A electrodes may be generally referred to as column electrodes. The sustain electrodes X may be paired with the scan electrodes Y, such that the X electrodes X₁ to Xₙ may respectively correspond to the Y electrodes Y₁ to Yₙ. An X electrode and a Y electrode of a pair may perform a display operation in order to display an image during a sustain period.

A discharge cell 12 may include a space formed at a region where an A electrode of the A electrodes A₁ to Aₘ crosses corresponding ones of the X and Y electrodes X₁ to Xₙ and Y₁ to Yₙ.

The above-described structure of the PDP 100 is merely exemplary, and panels of other structures may also be employed.

The controller 200 may receive externally-supplied video signals and may output an A electrode driving control signal, an X electrode driving control signal, and a Y electrode driving control signal. The controller 200 may control the plasma display device by dividing a field into a plurality of subfields. The controller 200 may divide the row electrodes into a first row group and a second row group. Further, the controller 200 may divide the first row group into a plurality of subgroups, and may divide the second row group into a plurality of subgroups.

The address electrode driver 300 may receive an A electrode driving control signal from the controller 200, and may supply a display data signal, for selecting discharge cells to be displayed, to the corresponding A electrodes.

The scan electrode driver 400 may receive the Y electrode driving control signal from the controller 200, and may supply a driving voltage to the Y electrode.

The sustain electrode driver 500 may receive the X electrode driving control signal from the controller 200, and may supply a driving voltage to the X electrode.

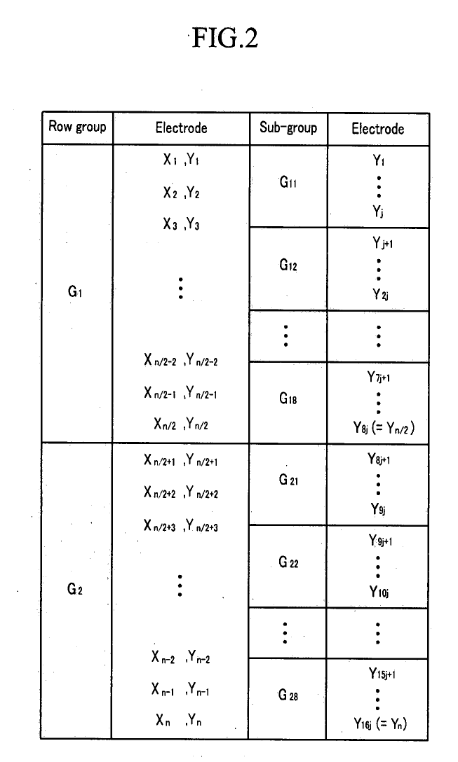

FIG. 2 illustrates a grouping of electrodes in a method of driving a plasma display device according to an embodiment. Referring to FIG. 2, in one field, row electrodes X₁ to Xₙ and Y₁ to Yₙ may be divided into two row groups G₁ and G₂. Row electrodes X₁ to X_{n/2} and Y₁ to Y_{n/2}, which may be positioned in a top portion of the PDP 100, may be grouped into the first row group G₁. Row electrodes X_{n/2+1} to Xₙ and Y_{n/2+1} to Yₙ, which may be positioned in a bottom portion of the PDP 100, may be grouped into the second row group G₂.

In another implementation (not shown), even-numbered row electrodes may be grouped into a first row group G₁ and odd-numbered row electrodes may be grouped into a second row group G₂. Further, the number of row groups is not limited to two.

Y electrodes in the first row group G₁ may be further divided into subgroups G₁₁ to G₁₈. Y electrodes in the second row group G₂ may be further divided into subgroups G₂₁ to G₂₈. For the sake of description, in FIG. 2 the first and second row groups G₁ and G₂ are respectively divided into eight subgroups G₁₁ to G₁₈ and G₂₁ to G₂₈. However, a different number of subgroups may be used.

In the first row group G₁, the Y electrodes Y₁ to Yⱼ may be grouped into the subgroup G₁₁, the Y electrodes Yⱼ₊₁ to Y₂ⱼ may be grouped into the sub group G₁₂, . . . , and the Y electrodes Y₇ⱼ₊₁ to Y₈ⱼ (Y_{n/2}) may be grouped in the subgroup G₁₈, where j is an integer and may be between, e.g., 1 and n/16, where n is an integer representing a number of row electrodes, e.g., a number of scan electrodes Y.

In a like manner, in the second row group G₂, the Y electrodes Y₈ⱼ₊₁ to Y₉ⱼ may be grouped into the subgroup G₂₁, the Y electrodes Y₉ⱼ₊₁ to Y₁₀ⱼ may be grouped into the subgroup G₂₂, . . . , and the Y electrodes Y₁₅ⱼ₊₁ to Yₙ may be grouped into the subgroup G₂₈.

Y electrodes having a constant distance from each other in the first and second row groups G₁ and G₂ may be grouped into one subgroup. In another implementation, the Y electrodes may be grouped according to an irregular order.

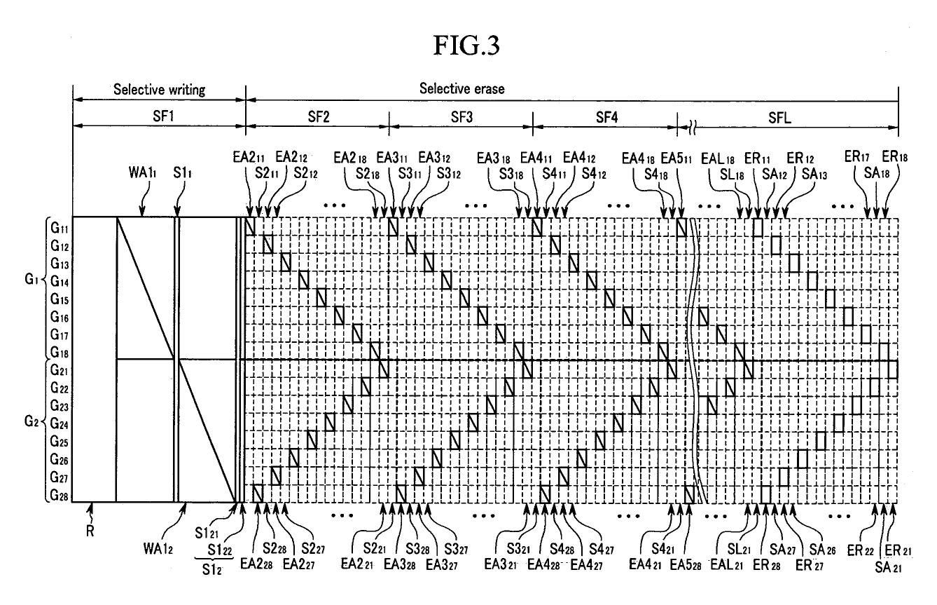

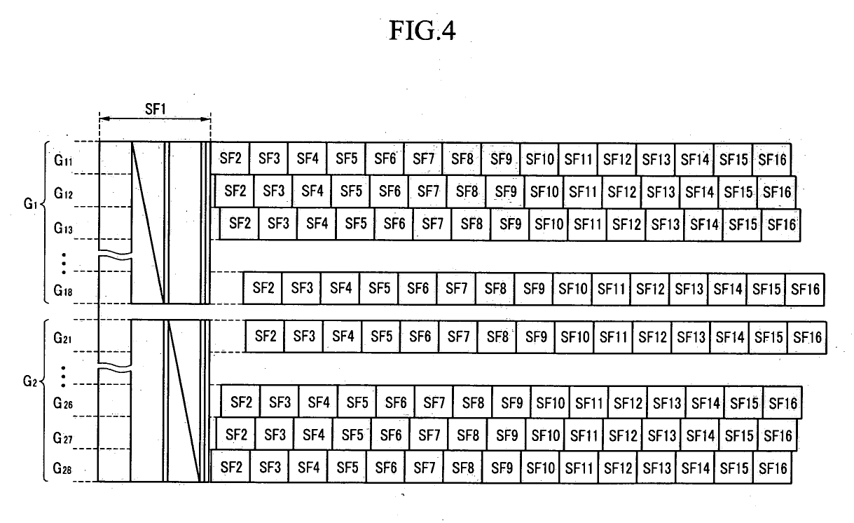

FIG. 3 illustrates subfields in the driving method of FIG. 2, and FIG. 4 illustrates another view of subfields in the driving method of FIG. 2. Referring to FIG. 3, one field may divided into L subfields SF1 to SFL. L is an integer and may be, e.g., 16. The first subfield SF1 may include a reset period R, write address periods WA1₁ and WA1₂, and sustain periods S1₁ and S1₂. The selective write method may be applied to the address periods WA1₁ and WA1₂.

The second to L-th subfields SF2 to SFL may include address periods EA2₁₁ to EAL₁₈ and EA2₂₁ to EAL₂₈, and sustain periods S2₁₁ to SL₁₈ and S2₂₁ to SL₂₈. A selective erase address method may be applied to the address periods EA2₁₁ to EAL₁₈ and EA2₂₁ to EAL₂₈ of the second to L-th subfields SF2 to SFL.

As described above with reference to FIG. 2, the row electrodes X₁ to Xₙ and Y₁ to Yₙ may be respectively grouped into first and second row groups G₁ and G₂, and the first and second row groups G₁ and G₂ may respectively include the Y electrodes Y₁ to Yₙ grouped into subgroups G₁₁ to G₁₈ and G₂₁ to G₂₈.

Referring to FIG. 3, in the first subfield having the address periods WA1₁ and WA1₂ employing the selective writing method, a reset period R may be provided temporally before the address periods WA1₂ and WA1₂ so as to initialize all of the discharge cells to be in the non-light emitting state. That is, in the reset period R of the first subfield SF1, all discharge cells may be reset to be non-light emitting cells so that they can be write-discharged in the address periods WA1₁ and WA1₂.

Wall charges may be formed by write-discharging discharge cells that are to be set as light emitting cells in the address period WA1₁, and light emitting cells of the first row group G₁ may be sustain-discharged in the sustain period S1₁. In this case, a minimum number of sustain discharges (e.g., one or two) may be generated in the sustain period S1₁.

In the address period WA1₂, wall charges may be formed by write-discharging discharge cells selected to be light emitting cells from among discharge cells of the second row group G₂. Discharge cells of the first and second row groups G₁ and G₂ may be sustain-discharged in a partial period S1₂₁ of the sustain period S1₂. In addition, the light emitting cells of the second row group G₂ may be sustain-discharged while the light emitting cells of the first row group G₁ are not in the state of being sustain-discharged during the partial period S1₂₂ of the sustain period S1₂. The number of sustain discharges generated in the discharge cells of the second row group G₂ during the partial period S1₂₂ of the sustain period S1₂ may be set to correspond to the number of sustain discharges generated in the discharge cells of the first row group G₁ during the sustain period S1₂.

Also, in the case that the two sustain periods S1₁ and S1₂ do not satisfy a weight value of the first subfield SF1, the light emitting cells of the first and second row groups G₁ and G₂ may be additionally sustain-discharged during the partial period S1₂₂ of the sustain period S1₂.

In the second subfield SF2, the address periods EA2₁₁ to EA2₁₈ and the sustain periods S2₁₁ to SL₁₈ may be sequentially applied from the subgroup G₁₁ to the subgroup G₁₈ of the first row group G₁, and the address periods EA2₂₈ to EA2₂₁, and the sustain periods S2₂₈ to SL₂₁ may be sequentially applied from the subgroup G₂₈ to the subgroup G₂₁.

The address periods EA3₁₁ to EAL₁₈ and EA3₂₁ to EAL₂₈ and the sustain periods S3₁₁ to SL₁₈ and S3₂₁ to SL₂₈ may be applied to the third through L-th subfields in similar fashion to that described above for the second subfield SF2. Since address and sustain operations during the address periods EA2₁₁ to EAL₁₈ and EA2₂₁ to EAL₂₈ and the sustain periods S2₁₁ to SL₁₈ and S2₂₁ to SL₂₈ may be substantially the same for the subfields SF2 to SFL, hereinafter these operations will be generally described as address operations EAk₁₁ to EAk₁₈ and EAk₂₁ to EAk₂₈ and sustain operations Sk₁₁ to Sk₁₈ and Sk₂₁ to Sk₂₈ applied to a k-th subfield SFk (where k is an integer, 2≦k≦L).

The sustain period Sk₁ᵢ may be applied to the subgroup G₁ᵢ after the address period EAk₁ᵢ is applied thereto in the subfield SFk of the row group G₁ (where i is an integer, 1≦i≦8). Subsequently, the address period EAk₁₍ᵢ₊₁₎ and the sustain period Sk₁₍ᵢ₊₁₎ may be applied to the subgroup G₁₍ᵢ₊₁₎.

In the subfield SFk of the second row group G₂, the sustain period Sk₂₍ᵢ₊₁₎ may be applied to the subgroup G₂₍ᵢ₊₁₎ after the address period EAk₂₍ᵢ₊₁₎ is applied. Subsequently, the address period EAk₂ᵢ and the sustain period Sk₂ᵢ may be applied to the subgroup G₂ᵢ. In this case, the address period EAk₂₍₈₋₍ᵢ₋₁₎₎ may be applied to the subgroup G₂₍₈₋₍ᵢ₋₁₎₎ while the sustain period Sk₁ᵢ is applied to the subgroup G₁ᵢ of the first row group G₁ in the subfield SFk. In addition, the address period EAk₁₍ᵢ₊₁₎ may be applied to the subgroup G₁₍ᵢ₊₁₎ of the first row group G₁ while the sustain period Sk₂₍₋₍ᵢ₋₁₎₎ is applied to the subgroup G₂₍₈₋₍ᵢ₋₁₎₎ of the second row group G₂ in the subfield SFₖ.

As shown in FIG. 3, the address periods EAk₂₈ to EAk₂₁ and the sustain periods Sk₂₈ to Sk₂₁ may be sequentially applied to the subgroup G₂₈ to the subgroup G₂₁ of the second row group G₂. In another implementation (not shown), the address periods EAk₂₁ to EAk₂₈ and the sustain periods Sk₂₁ to Sk₂₈ may instead be sequentially applied to the subgroup G₂₁ to the subgroup G₂₈, as in the first row group G₁. In addition, the address periods and the sustain periods may be applied according to a different order in the first and second row groups G₁ and G₂.

The respective subfields SF2 to SFL of the first row group G₁ will now be described in further detail. Wall charges may be erased by erase-discharging discharge cells that are selected to be non-light emitting cells from among light emitting cells of the first subgroup G₁₁ during the address period EAk₁₁ of the subfield SFk of the first row group G₁. Light emitting cells of the first subgroup G₁₁ may be sustain-discharged during the sustain period Sk₁₁. Subsequently, wall charges may be erased by erase-discharging discharge cells that are selected to be non-light emitting cells from among light emitting cells of the second subgroup G₁₂ during the address period EAk₁₂, and light emitting cells of the second subgroup G₁₂ may be sustain-discharged during the sustain period Sk₁₂. At this time, the light emitting cells of the first subgroup G₁₁ may be sustain-discharged. The address periods EAk₁₃ to EAk₁₈ and the sustain periods Sk₁₃ to Sk₁₈ may be applied to the subgroups G₁₃ to G₁₈ in the same manner as described above. The light emitting cells of the subgroup G₁ᵢ, the subgroups G₁₁ to G₁₍ᵢ₋₁₎, and the subgroups G₁₍ᵢ₊₁₎ to G₁₈ may be sustain-discharged. The light emitting cells of the subgroups G₁₁ to G₁₍ᵢ₋₁₎ may correspond to the light emitting cells that have not experienced an erase discharge during the respective address periods EAk₁₁ to EAk₁₍ᵢ₋₁₎. The light emitting cells of the subgroups G₁₍ᵢ₊₁₎ to G₁₈ may correspond to the light emitting cells that have not experienced the erase discharge during the respective address periods EA(k−1)₁₍ᵢ₊₁₎ to EA(k−1)₁₈.

In addition, the light emitting cells of the subgroup G₁ᵢ may be sustain-discharged until the sustain period SK₁₍ᵢ₋₁₎ before a subsequent address period EA(k+1)₁ᵢ of the subgroup G₁ᵢ of the first subgroup of the subfield SF(k+1). Thus, the light emitting cells of the subgroup G₁ᵢ may be sustain-discharged during eight sustain periods.

The address periods EA2₁₁ to EA2₁₈ and EAL₁₁ to EAL₁₈, and the sustain periods S2₁₁ to S2₁₈ and SL₁₁ to SL₁₈, may be applied to each of the subgroups G₁₁ to G₁₈ of the respective subfields SF1 to SFL. In this way, the discharge cells that are set to the light emitting state during the sustain periods S1₁ and S1₂ may be sustain-discharged until the discharge cells are erase-discharged in the respective subfields SF1 to SFL, whereby they may be switched to the non-light emitting state. After the discharge cells in the light emitting state are switched to the non-light emitting state due to the erase-discharge, no sustain discharge may be generated in the corresponding subfield. A weight value of each of the subfields SF2 to SFL may correspond to a sum of the lengths of eight sustain periods of the respective subfields.

When the sustain period SL₁₈ is applied to the subfield SFL, the sustain discharge may be performed eight times in the subgroup G₁₁, seven times in the subgroup G₁₂, six times in the subgroup G₁₃, five times in the subgroup G₁₄, four times in the subgroup G₁₅, three times in the subgroup G₁₆, twice in the subgroup G₁₇ and once in the subgroup G₁₈. However, it may be desirable for the subgroups G₁₁ to G₁₈ to have the same number of sustain discharges. For this purpose, the last subfield SFL of the first row group G₁ may include erase periods ER₁₁ to ER₁₇ and additional sustain periods SA₁₂ to SA₁₈.

In further detail, the subgroup G₁₁, where the sustain discharge is performed eight times immediately before subsequent erase periods, may not need an additional sustain period. Therefore, wall charges formed in the light emitting cells of the subgroup G₁₁ may be erased during the erase period ER₁₁. Then, the light emitting cells of the subgroups G₁₁ to G₁₈ may emit light during the additional sustain period SA₁₂. In this case, since the wall charges formed in the light emitting cells of the subgroup G₁₁ were erased during the erase period ER₁₁, the additional sustain discharge is performed once in the light emitting cells of the subgroups G₁₂ to G₁₈ during the additional sustain period SA₁₂.

In addition, since the subgroup G₁₂, where the sustain discharge is performed eight times due to the additional sustain period SA₁₂, may not need an additional sustain discharge, and wall charges formed in the light emitting cells of the subgroup G₁₂ may be erased during the erase period ER₁₂. Then, the light emitting cells of the subgroups G₁₁ to G₁₈ may emit light during the additional sustain period SA₁₃. In this case, the wall charges formed in the light emitting cells of the subgroups G₁₁ and G₁₂ were erased during the respective erase periods ER₁₁ and ER₁₂, and therefore the additional sustain discharge may be performed once in the light emitting cells of the subgroups G₁₃ to G₁₈ during the additional sustain period SA₁₃.

Subsequently, wall charges formed in the light emitting cells of the subgroup G₁₃ may be erased during the erase period ER₁₃, since the subgroup G₁₃, where the sustain discharge is performed eight times due to the additional sustain period A₁₃, may not need to experience an additional sustain discharge. Then, the light emitting cells of the subgroups G₁₁ to G₁₈ may emit light during the additional sustain period SA₁₄. In this case, since the wall charges formed in the subgroups G₁₁ to G₁₃ were erased during the respective erase periods ER₁₁ to ER₁₃, the additional sustain discharge may be performed once in the light emitting cells of the subgroups G₁₄ to G₁₈ respectively during the additional sustain period SA₁₄. Similarly, the same number of sustain discharges may be generated in the first to eighth subfields SF1 to SFL and may be set to correspond to each other by performing erase periods ER₁₄ to ER₁₇ and additional sustain periods SA₁₅ to SA₁₈.

An erase period ER₁₈ may be additionally performed so as to erase wall charges of the subgroup G₁₈ after the additional sustain period of the subgroup G₁₈. However, the erase period ER₁₈ may be omitted, since a reset period R may be applied to a subfield SF1 of the next consecutive field. The erase operation of the respective erase periods ER₁₁ to ER₁₈ may be sequentially performed for each row electrode of the respective subgroups, or may be simultaneously performed for all row electrodes of the respective row groups.

Referring again to FIG. 3, respective subfields SF2 to SFL of the second row group G₂ may be the same as those of the first row group G₁. However, address periods EA2₂₈ to EA2₂₁ and EAL₂₈ to EAL₂₁ may be applied from the subgroup G₂₈ to the subgroup G₂₁ in the respective subfields SF1 to SFL of the second row group G₂. Similarly, erase periods ER₂₁ to ER₂₈ may be applied from the subgroup G₂₈ to the subgroup G₂₁ in the last subfield SFL of the second row group G₂.

Referring to FIGS. 3 and 4, one field may be divided into 16 subfields SF1 to SF16. Each of the subgroups G₁₁ to G₁₈ and G₂₈ to G₂₁ may have a plurality of subfields SF2 to SF16 shifted by a predetermined period from each other, as shown in FIG. 4. For example, the subfield SF2 for the subgroup G₁₂ may be shifted with respect to the subfield SF2 for the subgroup G₁₁ by the predetermined period. The predetermined period may correspond to a sum of an address period EAk₁ᵢ (or EAk₂ᵢ, for the corresponding subgroup in the row group G₂) of the subgroup G₁ᵢ (G₂ᵢ) and a sustain period Sk₁ᵢ (Sk₂ᵢ) of the subgroup G₁ᵢ (G₂ᵢ).

In addition, the subfields of the second row group G₂ may be shifted with respect to those of the first row group G₁. In detail, assuming that the length of the address period EAk₁ᵢ (EAk₂ᵢ) of one of the subgroups G₁ᵢ (G₂ᵢ) corresponds to the length of the sustain period Sk₁ᵢ (Sk₂ᵢ) of one of the subgroups G₁ᵢ (G₂ᵢ), a starting point of the respective subfields SF2 to SF16 of the second row group G₂ may be shifted by a period between a starting point of the respective subfields SF2 to SF16 of the first row group G₁ and the address period EAk₁ᵢ (EAk₂ᵢ). For example, referring to FIG. 3, the starting point of the subfield SF2 of the second row group G₂ may be shifted, with respect to the starting point of the subfield SF2 of the first row group G₁, by a period equal to the address period EA2₁₁ of the subgroup G₁₁ of the first row group G₁.

The sustain period Sk₂₍ᵢ₋₁₎ may be applied to row electrodes of the second row group G₂ during the address period EAk₁ᵢ of each of the row electrodes of the first row G₁, and the sustain period Sk₂₍ᵢ₊₁₎ may be applied to row electrodes of the first row group G₁ during the address period EAk₂ᵢ of each of the row electrodes of the second row group G₂. That is, the address period EAk₁ᵢ or EAk₂ᵢ may be performed during the sustain period Sk₂₍ᵢ₋₁₎ or Sk₂₍ᵢ₊₁₎, rather than separating the address period EAk₁ᵢ or EAk₂ᵢ and the sustain period Sk₂₍ᵢ₋ₗ₎ or Sk₂₍ᵢ₊₁₎, and therefore the length of one subfield may be reduced. In addition, priming particles formed during the sustain periods Sk₁₁ to Sk₁₈ and Sk₂₁ to Sk₂₈ may be efficiently used during the address period EAk₁₂ to EAk₁₇ and EAk₂₂ to EAk₂₈, since the address periods EAk₁₂ to EAk₁₇ and EAk₂₂ to EAk₂₈ may be provided between sustain periods Sk₁₁ to Sk₁₈ and Sk₂₁ to Sk₂₈ of each of the subgroups G₁₁ to G₁₈ and G₂₁ to G₂₈, such that a scan pulse width may be reduced. This may enable a high speed scan. In addition, the contrast ratio may be increased by preventing a strong discharge from being generated during the reset period.

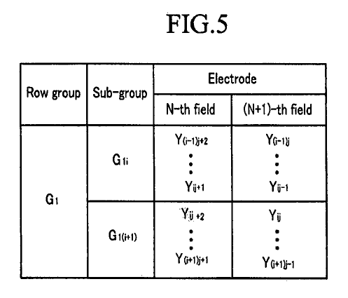

When driving the plurality of row electrodes by dividing them into a plurality of subgroups, a luminance difference may be generated in a boundary area of two adjacent subgroups. Such a luminance difference generated between two adjacent subgroups may be reduced using a driving method that will now be described in connection with FIG. 5, which illustrates details of electrode grouping in the driving method of FIG. 2. FIG. 5 generally shows the subgroup G₁ᵢ and the subgroup G₁₍ᵢ₊₁₎ of the first row group G₁.

Referring to FIG. 5, at least one Y electrode positioned in a boundary area of two adjacent subgroups may be alternately included in one of the two adjacent subgroups for consecutive fields N and N+1, where N is an integer.

For example, when a boundary between the subgroup G₁ᵢ and the subgroup G₁₍ᵢ₊₁₎ of the first row group G₁ is located between the Y electrode Yᵢⱼ and the Y electrode Yᵢⱼ₊₁ (see FIG. 2), for the first row group G₁ in the field N, the controller 200 may include the Y electrodes Y₍ᵢ₋ₗ₎ⱼ₊₂ to Yᵢⱼ₊₁ in the subgroup G₁ᵢ, and may include the Y electrodes Yᵢⱼ₊₂ to Y₍ᵢ₊₁₎ⱼ₊₁ in the subgroup G₁₍ᵢ₊₁₎ (see FIG. 5).

Then, for the first row group G₁ in the field N+1, which is consecutive to the field N, the Y electrodes Y₍ᵢ₋ₗ₎ⱼ to Yᵢⱼ₋ₗ may be included in the subgroup G11, and the Y electrodes Yᵢⱼ to Y₍ᵢ₊₁₎ⱼ₋₁ may be included in the subgroup G₁₍ᵢ₊₁₎.

In addition, the controller 200 may alternately apply a Y electrode to a plurality of subgroups G₂₁ to G₂₈ of the second row group G₂ in the manner illustrated in FIG. 5. The driving method of FIG. 5 may also be applied to a boundary between the first row group G₁ and the second row group G₂. In this way, the respective subgroups of each field may have a different boundary area, which may reduce a luminance difference occurring between adjacent subgroups.

As described above, a plurality of row electrodes may be divided into a first row group and a second row group. Row electrodes of the first and second groups may be further divided into a plurality of subgroups, respectively.

In addition, an address period may be performed in each of the respective subgroups of the first and second row groups in respective subfields of one field, and a sustain period may be performed between an address period of the respective subgroups. An address period of each subgroup of the second row group may be performed while a sustain period of each subgroup of the first row group is performed, and a sustain period of each subgroup of the first row group may be performed while an address period of each subgroup of the second row group is performed.

As described, an address period may be performed between sustain periods of the respective row groups, and therefore priming particles formed during the sustain period may be sufficiently utilized during the address period, thereby enabling high speed scanning by reducing the width of a scan pulse. Grayscale may be represented by subfields consecutively turned on from the first subfield, and therefore a false contour is prevented from being generated.

In addition, a luminance difference occurring between subgroups may be reduced by alternately driving at least one Y electrode that is positioned near a boundary of adjacent subgroups to the adjacent subgroups for each field.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a plasma display device having a plurality of row electrodes and a plurality of discharge cells corresponding to the row electrodes, in which a field is divided into a plurality of subfields, the method comprising:
dividing the plurality of row electrodes into at least a first row group and a second row group;
dividing the first row group into a plurality of first subgroups;
dividing the second row group into a plurality of second subgroups; and
address-discharging one of the first subgroups while sustain-discharging a corresponding one of the second subgroups during a predetermined subfield of a first field,
wherein at least one row electrode is part of one subgroup in a first field, and the at least one row electrode is part of another subgroup in a second field.

2. The method as claimed in claim 1, wherein the at least one row electrode is part of the first row group in the first field, and the at least one row electrode is part of the second row group in a second field.

3. The method as claimed in claim 1, wherein the at least one row electrode is part of a first subgroup in the first field, and the at least one row electrode is part of a second first subgroup in a second field.

4. The method as claimed in claim 1, wherein the row electrodes of the one subgroup and the row electrodes of the other subgroup are physically adjacent to each other.

5. The method as claimed in claim 4, wherein the at least one row electrode is positioned in an area adjacent to a boundary between the one subgroup and the other subgroup.

6. The method as claimed in claim 1, wherein a boundary between subgroups moves from a first physical region of the display to a second physical region of the display when the first field changes to the second field.

7. The method as claimed in claim 1, wherein the at least one row electrode is a scan electrode.

8. The method as claimed in claim 1, wherein the second field is consecutive to the first field.

9. The method as claimed in claim 1, wherein:
the at least one row electrode is part of the one subgroup in a third field, and
the first, second and third fields are consecutive.

10. The method as claimed in claim 1, wherein:
each subgroup includes an equal number of row electrodes during the first and second fields, and
a set of row electrodes forming the one subgroup during the first field is different from a set of row electrodes forming the one subgroup during the second field.

11. A plasma display device, comprising:
a plasma display panel having a plurality of row electrodes and a plurality of discharge cells corresponding to the row electrodes;
a controller configured to divide the plurality of row electrodes into at least a first row group and a second row group, to divide the first row group into a plurality of first subgroups, and to divide the second row group into a plurality of second subgroups; and
a driver configured to address-discharge one of the first subgroups while sustain-discharging a corresponding one of the second subgroups during a predetermined subfield of a first field,
wherein at least one row electrode is part of one subgroup in a first field, and the at least one row electrode is part of another subgroup in a second field.

12. The plasma display device as claimed in claim 11, wherein the at least one row electrode is part of the first row group in the first field, and the at least one row electrode is part of the second row group in a second field.

13. The plasma display device as claimed in claim 11, wherein the at least one row electrode is part of a first subgroup in the first field, and the at least one row electrode is part of a second first subgroup in a second field.

14. The plasma display device as claimed in claim 11, wherein the row electrodes of the one subgroup and the row electrodes of the other subgroup are physically adjacent to each other.

15. The plasma display device as claimed in claim 14, wherein the at least one row electrode is positioned in an area adjacent to a boundary between the one subgroup and the other subgroup.

16. The plasma display device as claimed in claim 11, wherein a boundary between subgroups moves from a first physical region of the display to a second physical region of the display when the first field changes to the second field.

17. The plasma display device as claimed in claim 11, wherein the at least one row electrode is a scan electrode.

18. The plasma display device as claimed in claim 11, wherein the second field is consecutive to the first field.

19. The plasma display device as claimed in claim 11, wherein:
the at least one row electrode is part of the one subgroup in a third field, and
the first, second and third fields are consecutive.

20. The plasma display device as claimed in claim 11, wherein:
each subgroup includes an equal number of row electrodes during the first and second fields, and
a set of row electrodes forming the one subgroup during the first field is different from a set of row electrodes forming the one subgroup during the second field.
